(19) United States
(12) Patent Application Publication
(10) Pub. No.: US 2013/0242091 A1
(43) Pub. Date: Sep. 19, 2013

(54) METHOD FOR SENSING FIRE AND TRANSFERRING FIRE INFORMATION

(71) Applicant: Dong Kwon PARK, Busan (KR)

(72) Inventor: Dong Kwon PARK, Busan (KR)

(21) Appl. No.: 13/548,436

(22) Filed: Jul. 13, 2012

(30) Foreign Application Priority Data
Mar. 19, 2012 (KR) 10-2012-0027924

(51) Int. Cl. H04N 7/18

(52) U.S. Cl. 348/143; 348/E07.085

(57) ABSTRACT

A method for real time fire detecting and transmitting fire information is disclosed. The method includes monitoring whether the fire related value of an area which fire and fire prevention state need to be monitored is in the fire occurrence set value in the fire occurrence through at least one of CO₂ sensor, temperature sensor, and image camera. When the fire related value is in the fire occurrence set value, an image camera rotates and shoots an image of the heaviest fire site and monitors the fire related value continuously. When the fire related value during fire is over the set range, the image camera rotates to the heaviest fire site from the present state and shoots an image of the heaviest fire site and, at the same time, monitors the fire related value by measuring CO₂ information, temperature information, and smoke information.

### CROSS-REFERENCE TO RELATED APPLICATIONS

This application claims priority under 35 U.S.C. §119 to Korean Patent Application No. 10-2012-0027924, filed on Mar. 19, 2012, in the Korean Intellectual Property Office, the entire contents of which are incorporated herein by reference.

### BACKGROUND

Example embodiments of inventive concepts relates to a method of real-time fire detecting and transferring fire information, and more particularly, to a method for informing fire information through a mobile device quickly in case of fire with people unattended and performing fire detection at the same time.

Recently, a camera for fire detection is being used for detecting accidental fire by a short circuit with people unattended by being installed inside the office, home, or factory.

The camera for fire detection has the composition of extinguishing fire by sounding alarm as well as informing fire to a fire control center and fast dispatching, when a control unit receives an image signal from an image device in the camera and the image signal is determined to be a fire state.

By the way, the camera shoots one area in case of fire, thereby failing to detect bigger fire when fire spreads to the other area. Thus, fast suppressing action may not be accomplished.

Also, the fire control center orders to mobilize to the fire site and puts out fire only after receiving image information about the fire state, accordingly, early suppression may not be easy because of the distance between the control center and the fire site. Also, even if the control center is close to the fire site, it is difficult to go close to the fire site in case that the fire site is a building concentrated area not by the roadside, thereby having a difficulty of fast early suppression.

### SUMMARY

The inventive concept aims to provide a method for fire detecting in real time and transmitting fire information so as to find a bigger fire site while tracking automatically.

The inventive concept also aims to provide a method for fire detecting in real time and transmitting fire information such that the fire state may be identified in real time and suppressed through a mobile device.

According to an example embodiment, there is provided a method for fire detecting in real time and transmitting fire information including monitoring whether the fire related value of a location which the fire and the prevention state is required to be monitored is below the fire occurrence set value in case of fire through at least one of CO₂ sensor, temperature sensor, smoke sensor, and image camera. The method includes operating a driving unit of camera so as to shoot an image of fire in the area of heaviest fire, when the fire related value goes in the fire occurrence set value and monitoring the fire related value continuously. The method further includes rotating the image camera to the area of heaviest fire from the present status automatically, when the fire related value becomes higher than the fire occurrence set value during fire and shooting an image of fire in the area of heaviest fire, and at the same time, monitoring the fire related value continuously by measuring CO₂ information, temperature information, and smoke information, continuously. The method further includes transmitting the image data taken by the control of the fire control unit to a predetermined mobile device, and at the same time, sounding an alarm on the mobile device.

At this time, the fire related value may be at least one of CO₂ release value, temperature, and smoke amount.

The rotating the image camera to the heaviest fire area is measuring color temperature information of each area while rotating the image camera and an infrared camera, transmitting the information to the control unit, and determining the heaviest fire site with the color temperature information by the transmitting unit.

The rotating the image camera to the area of heaviest fire is receiving color and size information of smoke in an image taken in real time while the control unit rotates the image camera and determining the heaviest fire site.

The obtaining the fire relate value may be accomplished by tabling a fire related signal transmitted through the CO₂ sensor, temperature sensor, and smoke sensor and measuring the fire related value with calculation of adding the weighted value to the tabled multiple signal.

Meanwhile, the method may further include operating an actuator for operating an extinguishment facility by a command from the mobile device.

### BRIEF DESCRIPTION OF THE DRAWINGS

Exemplary embodiments of the inventive concept will be more clearly understood from the following detailed description taken in conjunction with the accompanying drawings in which:

FIG. 1 is a schematic conceptual diagram illustrating an example of a fire detecting camera module performing a method for real time fire detection and transmitting fire information according to an exemplary embodiment of the inventive concept;

FIG. 2 is a block diagram illustrating each part of the fire detecting camera module of FIG. 1; and

FIG. 3 is a flow chart illustrating a method for real time fire detection and transmitting fire information that applicable to a fire detecting camera module having the above structure.

### EFFECT OF THE INVENTION

According to the inventive concept, when fire occurs, a camera rotates to find the bigger fire area and shoots the same. Accordingly, information of the fire site may be identified in real time.

Also, fire may be extinguished effectively in the initial stage by operating a fire extinguish facility of the fire site while checking the fire state through a mobile device in real time.

### DETAILED DESCRIPTION OF THE EMBODIMENTS

Various example embodiments will be described more fully hereinafter with reference to the accompanying drawings, in which some example embodiments are shown. Inventive concepts may, however, be embodied in many different forms and should not be construed as limited to the example embodiments set forth herein. Rather, example embodiments are provided so that this disclosure will be thorough and complete, and will fully convey the scope of inventive concepts to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

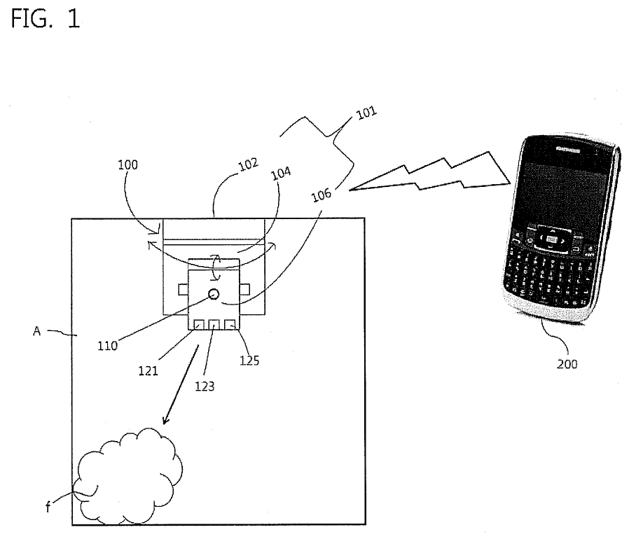

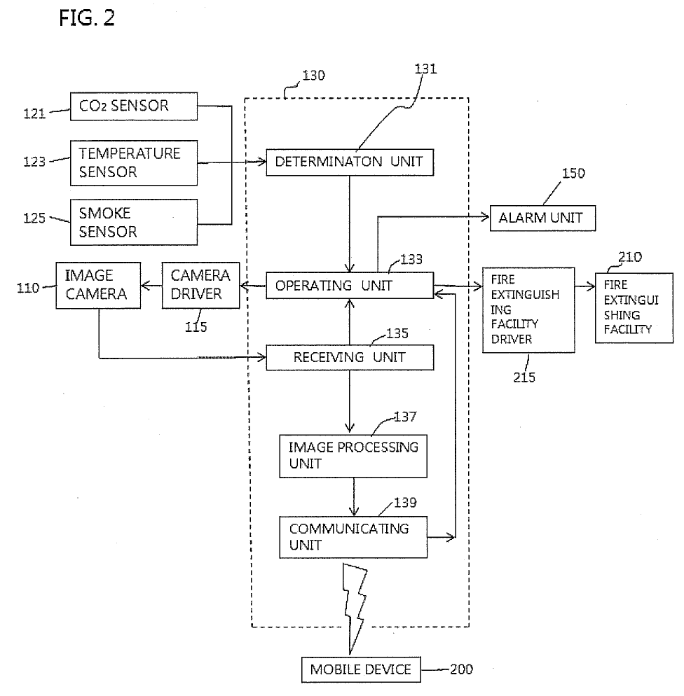

FIG. 1 is a conceptual schematic diagram illustrating an example of fire detecting camera module 100 applying a method for real time fire detection and transmitting fire information. FIG. 2 is a composition diagram of each part of the fire detecting camera module 100 of FIG. 1.

As shown in FIGS. 1 and 2, the fire detecting camera module 100 includes a module 101, a CO₂ sensor 121, a temperature sensor 123, a smoke sensor 125, an image camera 110, and a control unit 130.

The module 101 is desired to be installed at the position from which the area (A) required to be monitored may be taken. The module 101 may be installed so as to rotate from side to side and from front to rear. For this, the module 101 may include a fixing housing 102, a bracket combined to the fixing housing 102 so as to be horizontally rotatable, and a camera housing 106 combined to the bracket 104 so as to be rotatable upward and downward.

The camera housing 106 includes a CO₂ sensor 121, a temperature sensor 123, a smoke sensor 125, and an image camera 110. The CO₂ sensor 121 detects the CO₂ amount. The temperature sensor 123 detects a temperature of the fire monitoring area. The smoke sensor 125 may be an extinction-type, a laser particle type, and an ionization system type. Meanwhile, the fire detecting camera module 100 may further include an alarm unit 150.

The image camera 110 includes an image device (not shown) and a control unit 130.

The image device may include an image sensor such as CCD, CMOS, or the like, shooting an image. The image may be a normal image or infrared image.

Meanwhile, the camera housing 106 may further include an infrared camera. The infrared camera detects heat energy emitted from a predetermined location and displays the same as a temperature or an image.

The control unit 130 receives an image information taken by the image device, determines whether fire has occurs or not, sounds alarm or flashes alarm light through the alarm unit 150 so as to be identified by hearing or sight, and informs the fire occurrence to a protection center such as fire station and a mobile device 200 such as cell phone, smart phone, and PDA.

Especially, as shown in FIG. 2, the control unit 130 controls a receiver 135 receiving image information taken by the image device, an image processer 137 processing to record or reproduce the received image information, a determination unit 131, and an extinguishing facility driver 215 for operating an alarm unit 150 and a fire extinguishing facility 210 located in the fire site, and at the same time, includes an operating unit 133 operates and controls a camera driver 115 and a communication unit 139 having a transceiver method for providing the determined information to the mobile device 200. The communication unit 139 may provide the determined information to a fire prevention sensor.

The image processing unit 137 performs a function of controlling the image device to shoot the fire site through the focusing and tracking operation, when infrared rays released from the fire in the monitoring area of the image camera 110 or the infrared camera are detected and a temperature higher than the set temperature is detected through the temperature sensor or the smoke sensor 125.

The determination unit 131 may extract the fire determination and the fire location (f) as well as the temperature data and the smoke data exactly through a database in which a location data is stored, based on the image information and infrared information provided by the image processor 137.

The fire extinction facility driver 215 may be controlled by the operating unit 133 directly, but the fire extinction facility driver 215 may have a communication device for communicating with the mobile device 200 so as to be controlled through the mobile device 200 from a distant place.

The fire extinction facility driver 215 may control the open/close operation for providing extinguishing fluid or extinguishing water to the fire extinguishing facility 210, such as fire hydrant, fire extinguisher, spring cooler, and fire prevention door, and the adjustment of the angle and the direction of spraying, and the open/close operation of the fire prevention door through wireless.

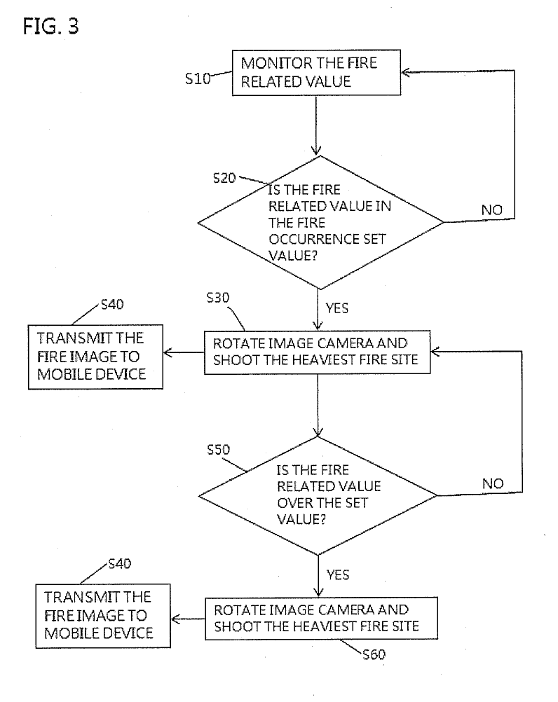

FIG. 3 is a flow chart illustrating a method for real time fire detecting and transmitting fire information applicable to the fire detecting camera module 100 having the above structure. Referring to FIGS. 1 through 3, a process for detecting fire and suppressing the fire through the fire detecting camera module 100 according to an exemplary embodiment of the present invention is described hereinafter.

First, the process includes monitoring (S10) the fire related value of the area which the fire and the prevention status need to be monitored through the CO₂ sensor 121, the temperature sensor 123, and the smoke sensor 125. At this time, the CO₂ sensor 121 checks the CO₂ amount, and the temperature sensor 123 checks the temperature value, and the smoke sensor 125 checks the smoke amount. Accordingly, the fire related value may be monitored.

The fire related value may be at least one of CO₂ value, temperature value, and smoke value. Unlike this, the fire related value may be obtained by tabling the fire related signal transmitted through the CO₂ sensor 121, the temperature sensor 123, and the smoke sensor 125 and measuring the fire related value after calculation of adding a weighted value to the tabled detecting multiple signal.

The monitoring the fire related value enables to monitor whether the fire related value is in the fire occurrence set value by comparing with the predetermined fire occurrence set value by the determination unit 131.

Unlike this, the fire monitoring area is taken by the image device of the image camera 110 usually and the image information is transmitted to the control unit 130. The transmitted image information is processed by the receiving unit 135 and the image processing unit 137, and when the image is a usual image, the image is stored in a database or displayed on a monitor through the determination unit 131, and it can be determined whether the fire state or not while the image information goes through the receiving unit 135, the image processing unit 137, and the determination unit 131.

At this time, in case that the obtained fire related value goes in the fire occurrence set value (S20), the image camera 110 rotates, shoots a fire image of the heaviest fire site, and at the same time, measures the fire related value is continuously (S30).

The step S30 may determine the heaviest fire site by receiving the color and the size information of the smoke of the image taken in real time while the camera 110 is rotating.

Also, the camera housing 106 of the camera module includes the image camera 110 and the infrared camera. The color temperature information of each area is measured while rotating the infrared camera and transmitted into the control unit 130, and the transmitting unit may determine the heaviest fire site with the color temperature information.

When the fire related value goes in the fire occurrence set value, the determination unit 131 controls the alarm unit 150 to inform the fire state through sounding and sight.

At the same time, the fire extinguishing driver 215 for controlling the fire extinguishing facility in the fire area is operated to open the fire extinguishing facility so as to spray extinguishing fluid or extinguishing water and the angle of a spraying nozzle to the fire area, thereby suppressing the fire in the initial stage.

Also, the determination unit 131 informs a fire prevention center such as fire station and a user (building owner, camera installer, or manager)'s mobile device 200 of the fire occurrence through the SNS message or alarm (S40).

Then, the fire prevention center confirms the location of the communicating unit 139 providing transmitting information through tracking or a predetermined code and dispatches a fire engine or the like to the site such that the fire which has not been suppressed by the fire extinguishing facility driver 215 may be suppressed quickly.

Also, the user informed of the fire state through the mobile device 200 may check the situation of the heaviest fire site with eye, and in addition, the fire may be suppressed by operating the fire extinguishing driver 215 directly from a distance through connection with the communication device of the fire extinguishing driver 215.

Even though the image camera 110 is shooting the heaviest fire site, the fire related value is measured continuously for determining whether the fire related value becomes higher than the set range (S50). At this time, the control unit 130 sets a set range for rotating the image camera 110 adjusting to the fire related value. The set range is desired to be adjustable.

If the fire related value is above the set range, it may denote that another area in a heavier fire than presently shooting area may exist.

Accordingly, if the fire related value is above the set range, the image camera 110 finds the heaviest fire site while rotating and shoots the area (S60).

The method for finding the heaviest fire site is identical to the method for finding the heaviest fire site when fire occurrence, therefore, a description thereof is omitted.

According to an exemplary embodiment of the inventive concept, the image camera shoots the heaviest fire site with auto tracking. Accordingly, the heaviest fire site may be identified exactly in real time, thereby being treated quickly.

Also, the bigger fire that may occur due to not proceeding after treatment may be prevented, because misidentifying fire to be suppressed even though other area is still under the fire may be prevented.

Also, human life and property damage may be minimized through suppression by a prevention center and a mobile device with remote control suppression as well as self fire extinguishment after identifying the fire area quickly.

While the present invention has been particularly shown and described with reference to exemplary embodiments thereof, it will be understood that various changes in form and details may be made therein without departing from the spirit and scope of the following claims.

What is claimed is:

1. A method for real time fire detecting and transmitting fire information comprises:
monitoring whether the fire related value of the area which fire and prevention state needs to be monitored through at least one of CO₂ sensor, temperature sensor, smoke sensor, and image camera is in the fire occurrence set value;
rotating the image camera by operating a camera driver, when the fire related value is in the fire occurrence set value, so as to shoot a fire image of the heaviest fire site, and monitoring the fire related value continuously;
rotating the image camera from present state to the heaviest fire site automatically, when the fire related value measured during fire is above the set range, so as to shoot a fire image of the heaviest fire site, and monitoring the fire related value by measuring CO₂ information, temperature information, and smoke information, continuously; and
transmitting an image data taken by the control of a control unit into a predetermined mobile device in real time and sounding an alarm on the mobile device.

2. The method for real time fire detecting and transmitting fire information of claim 1, wherein the fire related value is at least one of CO₂ emitting value, temperature, and smoke amount.

3. The method for real time fire detecting and transmitting fire information of claim 1, wherein the rotating the image camera to the heaviest fire site comprises;
measuring color temperature information of each area while rotating an infrared camera along with the image camera; and
determining the heaviest fire site with the color temperature information.

4. The method for real time fire detecting and transmitting fire information of claim 1, wherein the control unit determines the heaviest fire site by receiving the color and the size information taken by the image camera while rotating.

5. The method for real time fire detecting and transmitting fire information of claim 1, wherein the obtaining the fire related value includes tabling a fire related signal transmitted from the CO₂ sensor, the temperature sensor and the smoke sensor and calculating of adding a weighted value to the tabled sense multiple signal.

6. The method for real time fire detecting and transmitting fire information of claim 1, wherein the method further includes operating an actuator of fire extinguishing facility of the fire site according to the comment of the mobile device.
